(19) United States
(12) Patent Application Publication
(10) Pub. No.: US 2022/0085492 A1
(43) Pub. Date: Mar. 17, 2022

(54) COURSE GUIDANCE FOR A SELF-DRIVING VEHICLE

(71) Applicant: Martin Joseph Bodo, Los Alto Hills, CA (US)

(72) Inventor: Martin Joseph Bodo, Los Alto Hills, CA (US)

(21) Appl. No.: 17/532,785

(22) Filed: Nov. 22, 2021

Related U.S. Application Data
(63) Continuation of application No. 14/691,433, filed on Apr. 20, 2015, now abandoned.
(60) Provisional application No. 61/981,728, filed on Apr. 18, 2014.

(51) Int. Cl. H01Q 1/32; G01S 13/42; G01S 13/931; G01S 13/75; H01Q 19/10; G01S 13/87

(52) U.S. Cl. CPC H01Q 1/3291; G01S 13/426; G01S 13/931; G01S 2013/0245; H01Q 1/3233; H01Q 19/106; G01S 13/876; G01S 13/751

(57) ABSTRACT

A tracking system uses a road mounted microwave reflector as an alignment tool. The system can be used to provide primary or supplemental guidance and alignment for a self-driving vehicle, or it can be used to provide warning signals for a manually controlled vehicle. The disclosed reflector is economical and easily installed. A preferred corner reflector includes both a microwave retro reflector and an embedded tuned circuit. The system is optimized to operate reliability and accurately in conditions of inclement weather and poor visibility, particularly where GPS signals, conventional road markers and visual aids fail.

### CLAIM OF PROVISIONAL APPLICATION RIGHTS

This patent application claims the benefit of U.S. Provisional Patent Application No. 61/981,728 filed on Apr. 18, 2014.

### BACKGROUND

### Technical Field

The present invention relates to the fields of autonomous vehicle guidance systems and vehicular steering, tracking and alignment.

### Background Art

Technology that enables self-driving vehicles is not new. Many industrial vehicles such as autonomously operated forklifts receive radio frequency (“RF”) signals to guide their travel along a predetermined path. Other vehicles have used sonar and radar system for vehicle guidance and position warning.

A popular low-cost, high-accuracy vehicle control, system is frequently referred to as “wire-guided.” In a wire-guided system, a transmitter that operates continuously applies an RF signal to a wire embedded in the surface of a road or track. This wire emits an RF signal which is tracked by a receiver mounted on the vehicle. Wire-guided systems such as those used in warehouse forklifts can provide tracking accuracy to within 1.0 centimeter (“cm”).

For example, U.S. Pat. No. 4,307,329 entitled “Wire Guidance Method and Apparatus” that issued Dec. 22, 1981, on a patent application filed by Charles L. Taylor discloses a ground vehicle guidance system for following a current-carrying guidewire. The wire-guided system disclosed in this patent provides improved steering stability over a wide range of speeds, and improved immunity to inductive field anomalies by computing vehicle heading and lateral displacement using sensor signals themselves substantially insensitive to heading variations. The sensor signals are processed to provide steering command signals having a specified relationship to vehicle steering geometry. In this way desired damping factors can be obtained for both forward and reverse travel. The disclosed system also includes improved vehicle speed limiting and stopping circuits that independently control truck operation in accordance with computed heading and with lateral displacement deviations. The patent also discloses steering systems both for vehicles using steerable wheels and vehicles steered by differential drive wheel speed control. U.S. Pat. No. 5,404,087 entitled “Automated Guided Vehicle Wire Guidance Apparatus” that issued Apr. 4, 1995, on a patent application filed by Leigh E. Sherman discloses a wire-guided apparatus for an automated guided vehicle. This wire-guided apparatus includes a first crossed coil sensor for acquiring a wire and tracking along curves in the wire as the vehicle is travelling in the forward direction. A second crossed coil sensor included in the wire-guided apparatus acquires the wire and tracking along the wire when the vehicle is travelling in the reverse direction. Third and fourth sensors included in the wire-guided apparatus track along straight runs in the wire. Circuitry included in the wire-guided apparatus switches between the first and second crossed coil sensors and the third and fourth sensors. Circuitry included in the wire-guided apparatus also generates a guidance error signal from the outputs of either:
1. the first or second crossed coil sensors; or
2. both the third and fourth sensors.
   The guidance error signal is then used to control a motor connected to a steerable wheel of the vehicle to maintain the vehicle in alignment with the wire.

Wire-guided systems offer excellent, performance in adverse conditions, but suffer from significant disadvantages which make them impractical for installing a long public road. Perhaps the most significant disadvantage with wire-guided systems is their requirement for powered transmitters. Transmitters are expensive and the wire-guided system cannot be used where there is no reliable electrical power, or where power is too expensive to install. Over longer distances, this disadvantage increases because multiple transmitters are required due to RF signal attenuation along the wire located far from a transmitter. Consequently, at some point the number of transmitters and the amount of electrical power becomes economically prohibitive for a wire-guided system.

A second disadvantage of the wire-guided system is the necessity to bury a conductor beneath a road's surface. Burying a cable can be difficult and costly, and can impair the road's structural integrity.

A third disadvantage of the wired guided system is the lack of two-dimensional position information. A wire-guided system can guide a vehicle from side to side perpendicular to the wire axis, providing a single axis for steering, but it cannot provide a second axis of information containing a vehicle's longitudinal position along the length of the wire.

UK Patent Application G3 2 277 152 entitled “Localizing Systems For Robotic Vehicles” that was published Oct. 19, 1994, on a patent application filed in the name of Gareth Anthony Edwards discloses a localizing system and method suitable for use in a robotic lawn mower. The disclosed system includes plurality of spaced reference stations that are associated with an area to be worked by the lawn mower. The reference stations are located in relation to the area and the operating lawn mower communicates with two or more of the spaced reference stations to determine its distance from and bearing with respect thereto. In this way the mobile lawn mower localizes itself in relation to the working area. Thus, the mobile lawn mower is capable of carrying out a task over at least part of the working area in a controlled manner. The UK patent application discloses that communication between the lawn mower and the reference stations may be effected using ultrasonic or electromagnetic radiation.

European Patent Application EP 2006703 entitled “Localizing System For a Robotic Vehicles” that was published Dec. 24, 2008, on a patent application filed in the name of Jurgen Seidel and others discloses a system having a transmission unit for transmitting an electromagnetic signal toward active reflecting landmarks, and a receiver unit for receiving electromagnetic signals reflected from respective landmarks. A control unit included in the system determines a robotic vehicle's position based on the reflected electromagnetic signals received by the receiving unit. Each reflecting landmark is distinguished from other landmarks by a unique reflection characteristics, preferably a difference in reflected signal modulation intensity profile. The patent application discloses that landmarks having a different number of reflection elements and/or differently shaped reflective elements produce differing modulation intensity profiles particularly if the landmarks move such as by each landmark's rotation. In this way the intensity of the signal reflected from various landmarks differs and identification of the landmarks becomes possible by comparing reflected signal intensities.

With the ever increasing likelihood of self-driving passenger vehicles traveling on public roads, safe operation has become paramount. To avoid accidents and their corresponding liabilities, and to increase public acceptance of autonomous technology, self-driving vehicles must be built to the highest safety and reliability standards. Reliable vehicle position information is more critical than ever for safety.

Today's self-driving vehicles use a combination of global positioning system (“GPS”), inertial, visual, cameras, ultrasonic and radar guidance position information. With appropriate corrections GPS can provide position accuracy to within 3.0 meters (3.0 m). To achieve greater accuracy, GPS data is typically combined with map data and inertial guidance. Radar or ultrasonic sensors are used to detect nearby objects, and other moving vehicles, and while parking. The reliability of all these systems can be degraded by adverse environmental conditions.

Environmental conditions which degrade the accuracy of these conventional sensors include inclement weather, foliage cover, ice, snow and fog. For example, GPS is prone to RF interference and its performance can be impaired by foliage and trees.

Visual guidance via digital cameras and/or lidar helps keep today's self-driving vehicle centered in its lane, but camera vision and lidar are impaired by weather, dust, smoke, and heat. Visual guidance systems may also be blocked by other vehicles. In addition, visual guidance systems are limited to visible road markings, which may be obscured, hard to detect, missing, in poor condition, or spaced far apart.

### BRIEF SUMMARY

An object of the present disclosure is to improve self-driving vehicle performance and safety.

Another object of the present disclosure is to provide a simple and economical system for use in self-driving vehicles.

Another object of the present disclosure is to provide a highly reliable system having no moving parts.

Another object of the present disclosure is to provide a system for use in self-driving vehicles having improved performance in adverse environmental conditions.

Another object of the present disclosure is to provide supplemental guidance for self-driving vehicles that is reliable, economical and practical to install along long roads.

Briefly, a transceiver detects the presence of road mounted microwave reflectors to accurately position a vehicle regardless inclement weather or outside interference. This system provides high accuracy at very low cost while being easy-to-install on existing roadways. While this system overcomes drawbacks of other guidance methods, it is best used to augment all of the various guidance techniques and to improve guidance system performance in adverse environmental conditions. For example, the system might be used only where increased performance and accuracy is needed, for example on a mountain pass which frequently experiences snow and ice.

The disclosed transceiver is adapted for inclusion in a guidance system for a self-driving vehicle that is driveable along a road having passive corner reflectors secured thereto. The transceiver includes a transmitter having a transmitting antenna. When the transceiver operates the transceiver's transmitting antennae projects a steered, pencil-shaped transmitted beam ahead of the self-driving vehicle. The transmitted beam is swept rapidly from side-to-side across the road in front of the moving self-driving vehicle, Movement of the self-driving vehicle combined with sweeping of the pencil-shaped transmitted beam from side-to-side across the road in front of the moving self-driving vehicle causes the transmitted beam to intermittently impinge upon corner reflectors secured to the road. The transceiver also includes a receiver having a directional receiving antenna that points toward a location where the swept transmitted beam will intermittently impinge upon corner reflectors secured to the road. The receiving antenna receives that portion of the transmitted beam impinging on corner reflectors which individual corner reflectors echo back toward the receiving antenna.

Advantageously, system is simple and economical since it requires only a single axis track of reflectors. If the position and spacing of reflectors is known, in combination with an accurate clock vehicle speed can be accurately determined and checked.

However, the spacing between corner reflectors need not be a fixed distance. In areas where the road forks or makes sharp turns, for example, corner reflectors may be spaced closer together. In long, straight stretches of road, corner reflectors may be spaced further apart.

Corner reflectors having different resonant frequencies may be used for indicating the presence of particular types of landmarks, e.g. freeway exits, fire hydrants, etc.

These and other features, objects and advantages will be understood or apparent to those of ordinary skill in the art from the following detailed description of the preferred embodiment as illustrated in the various drawing figures.

### BRIEF DESCRIPTION OF THE DRAWINGS

FIG. 1 is a plan view of a single face of corner reflector in accordance with the present disclosure;

FIG. 2 is a plan view of a corner reflector's individual faces that are depicted in FIG. 1 arranged as three faces of a tetrahedron;

FIG. 3 is a cross-sectional perspective view of a road having the corner reflector of FIG. 2 implanted flush therein;

FIG. 4 is a cross-sectional perspective view of the corner reflector of FIG. 3 implanted in a conventional highway reflector;

FIG. 5 is a block diagram depicting a preferred embodiment of a transceiver in accordance with the present disclosure;

FIG. 6 is an elevational view of a self-driving vehicle having a transceiver of the type depicted in FIG. 5 mounted thereon for transmitting a RF signal to be echoed from corner reflectors implanted in the road as depicted in FIG. 3;

FIGS. 7-9 are similar to FIGS. 1-3 that depict a preferred face for inclusion in a corner reflector and corner reflectors that include the preferred face, the preferred face being configured to provide improved resonance at a transmitter's center operating frequency;

FIG. 10 is a spectrum diagram illustrating performance of the corner reflectors depicted in FIGS. 8 and 9 having the resonant structure best illustrated in FIG. 7 compared with a similar corner reflector that lacks the resonant structure; and

FIG. 11 is a block diagram illustrating inclusion of a vehicular transceiver in accordance with the present disclosure in a vehicle guidance system.

### DETAILED DESCRIPTION

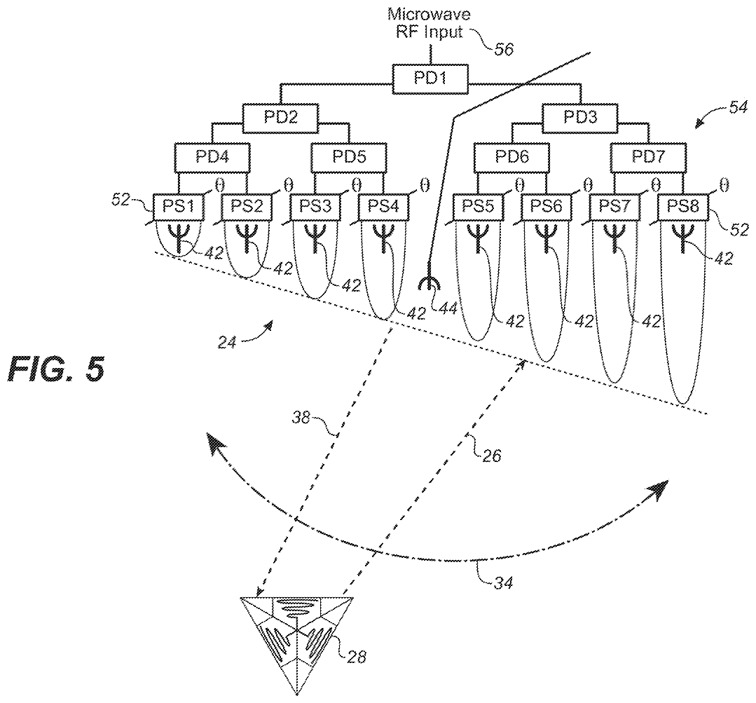

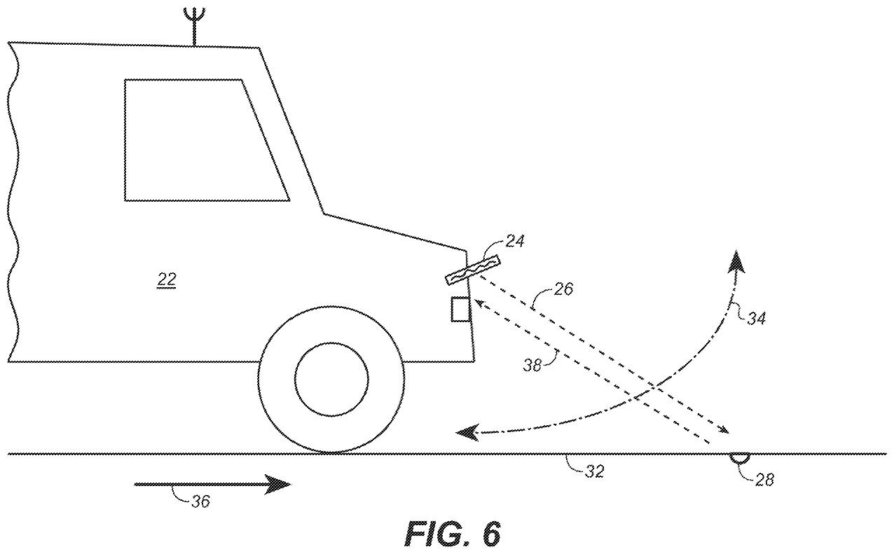

FIG. 6 depicts a self-driving vehicle 22 having a transceiver 24 in accordance with the present disclosure mounted thereon. The transceiver 24 projects a steered, pencil-shaped transmitted microwave beam, indicated by a dashed arrow 26 in FIG. 6, ahead of the self-driving vehicle 22 toward a corner reflector 28 implanted in a road 32. As depicted by a curved, dashed arrow 34 in FIG. 5, the transceiver 24 sweeps the transmitted beam from side-to-side across the road 32 in front of the self-driving vehicle 22. As depicted in FIG. 6, movement of the self-driving vehicle 22 along the road 32, indicated by an arrow 36 in FIG. 6, combined with sweeping of the pencil-shaped transmitted beam from side-to-side across the road 32 in front of the moving self-driving vehicle 22 causes the transmitted beam to intermittently impinge upon corner corner reflectors 28 secured to the road 32. When the transmitted beam impinges on a corner reflector 28, the corner reflector 28 echoes a portion of the transmitted beam back toward the transceiver 24, indicated by a dashed arrow 38 in FIG. 6. In addition to projecting the transmitted beam, the transceiver 24 receives that portion of the transmitted beam echoed back toward the transceiver 24 from corner reflector 28.

Referring now to FIG. 5, as is well known to those skilled in the art of microwave transceivers, the preferred transceiver 24 includes:

1. a plurality of transmitting antennae 42; and

2. at least one receiving antenna 44 that connect to a receiver that is included in the transceiver 24.

The transceiver also includes a horizontal row of phase shifters 52, one phase shifter 52 respectively connected to each of the transmitting antennae 42, and a network of power dividers 54 connected between the phase shifters 52 and a source of microwave power 56. The power dividers 54 supply equal amounts of RF power received from the source of microwave power 56 to each of the phase shifters 52.

As is those skilled in the art know, each phase shifter 52 may be implemented using an ensemble of detour lines having lengths chosen so that PIN diodes, connected between pairs of detour lines, may be appropriately switched for delaying the microwave signal received by the phase shifter 52 from the power dividers 54 by a specified amount. The PIN diodes produce the desired delay by routing the received microwave signal through appropriately selected detour lines.

Configured in this way, the transmitting portion of the preferred transceiver 24 constitutes a passive electronically scanned array (“PESA”), also known as passive phased array. A PESA has a central radio frequency source (such as a magnetron, a klystron a travelling wave tube, or a frequency synthesizer), sending RF energy into the phase shifters 52 via the power dividers 54 for retransmission into the transmitting antennae 42. Signals supplied to the phase shifters 52 form microwave energy received from the source of microwave power 56 into the steered, pencil-shaped transmitted microwave beam that, as indicated by the curved, dashed arrow 34, sweeps from side-to-side across the road 32, preferably in a sawtooth pattern. Microwave energy formed into the transmitted beam preferably includes microwave frequencies that are no less than two gigahertz (2.0 GHZ). The frequency should as high as possible to minimize the physical size of the corner reflector 28, but not so high that serious attenuation will occur when the corner reflector 28 is covered with ice, water, and/or road debris.

It should be apparent to one of ordinary skill that the source of microwave power 56 can supply any frequency in the SHF band. Higher frequencies yield the advantage of a smaller corner reflector 28, and lower frequencies have the advantage of a lower cost transmitter and less path-less attenuation due to water. ISM bands allow unlicensed operation in most countries. The 24 GHz ISM band is a possible frequency range which works quite well with a corner reflector 23 as small as one-half inch (0.5″) in diameter.

The phase shifters 52 for sweeping the transmitted beam from side-to-side may be as simple as a tuned circuit incorporating a varactor diode, where the diode is tuned by an oscillating voltage corresponding to the sweep frequency. A more elegant type of phase shifters 52 uses a different fixed reactance in each phase shifter 52. For this type of phase shifter 52, sweeping the transmitted frequency over a relatively small range causes the transmitted beam to swing in an arc. Because synthesized microwave transmitters are very common and inexpensive, this second configuration for the phase shifters 52 provides a practical transmitter having a relatively low parts count. Since the bandwidth required to steer the beam is small compared to the bandwidth of the corner reflector 28, there is no significant reduction in that portion of the transmitted beam echoed back from corner reflectors 28 toward the transceiver 24 due to frequency sweeping. Moreover, sweeping the frequency of microwave RF projected from the transceiver 24 may be exploited advantageously for distinguishing the corner reflector 28 from other microwave reflecting objects such as metallic candy wrappers.

To reduce costs, the entire transmitting circuit, including phase shifters 52, power dividers 54, and transmitting antennae 42 may be constructed on a single glass-epoxy printed circuit board, with the majority of the power divider and antennae structures, and parts of the phase shifters 52 constructed of copper traces. The power dividers 54 may be either resistive or electromagnetic.

While similar to a conventional radar the transmitting antennae 42 might be used for receiving that portion of the transmitted beam echoed from the corner reflector 28 back toward the transceiver 24, to simplify the transceiver 24 it preferably has the separate receiving antenna 44 depicted in FIG. 5 thereby allowing continuously projecting the transmitted beam. The design of the receiving antenna 44 is not critical and can be a directional horn, shielded dipole, or any similar directional antenna with a forward lobe sufficient to receive reflected signals over the entire range of arc, i.e. plus or minus sixty degrees (±60°). Presently, the preferred receiving antenna 44 is a “horn” to waveguide adapter. This configuration for the receiving antenna 44 receives the reflected a portion of the transmitted beam throughout an aperture that is approximately:
1. plus or minus sixty degrees (±60°) horizontally; and
2. ten degrees (10°) vertically.
   Stated alternatively, the receiving area is sensitive only in a rectangular area pointed in the same direction as the transmitting antennae 42. In this way the receiving antenna 44 picks up only RF directly reflected from the corner reflector 28, and ignores interfering signals from outside the rectangular area. The receiving antenna 44 should be shielded to prevent receiving interference from directions other than the intended sensing area.

It should be apparent that a set of conventional microwave corner reflectors may be used for position sensing. In using a conventional corner reflectors, however, two difficulties arise. First, the corner reflector must have high reflectivity which usually means a large surface area thereby making the corner reflector unsuitable for implantation in a road. Second, the corner reflector must be uniquely distinguishable from other objects that are highly reflective to microwave, signals such as a foil candy wrapper.

Disclosed herein are corner reflectors 28 that are small, sealed and can be embedded flush with the surface of the road 32. Flush surface mounting allows the corner reflectors 28 to survive installation on roads which may be exposed to snowplows. The disclosed corner reflectors 28 utilize a corner reflector having a tuned circuit. The tuned circuit provides an identifying resonant reflective response which allows unique identification by the transceiver 24.

Disclosed herein are corner reflector 28 that can be installed in any rotational orientation about its vertical axis without affecting its performance. To map locations of corner reflectors 28, a surveyor may use a combination of maps, road markings, and fixed differential GPS signals. As illustrated in FIG. 3, installing corner reflectors 28 requires only a small cavity in the road 32 approximately one-half inch (0.5″) deep. This small cavity may be quickly drilled in cement or simply pressed into asphalt. Epoxy may be used in affixing each corner reflector 28 to the road 32. The disclosed corner reflector 28 may be covered with epoxy, and the road 32 may be lightly repaved without impairing operation of the corner reflector 28. Since the corner reflector 23 is beneath the surface of the road 32, road cleaning equipment such as snow plows will not dislodge it.

The high reflectivity and sharp resonance characteristics of the preferred corner reflector permit using a relatively low power transmitter operating at a frequency that matches the peak resonance frequency of the preferred corner reflector.

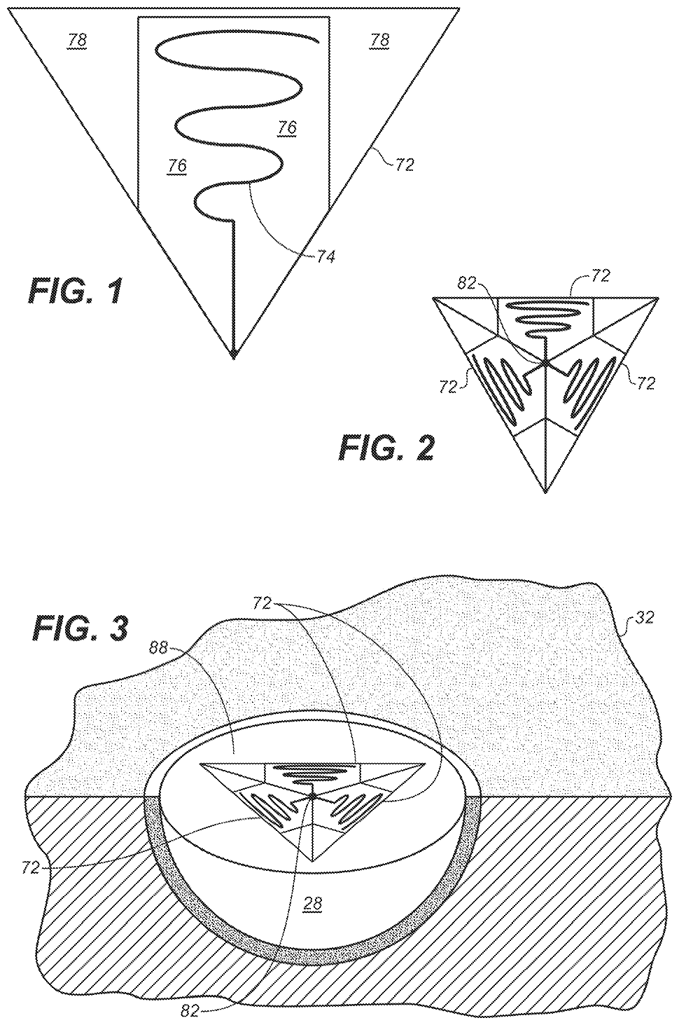

FIGS. 1-3 depict various aspects of a corner reflector 28 that might be implanted in the road 32. Each corner reflector 28, depicted in FIGS. 2 and 3, is assembled by juxtaposing three identical triangularly-shaped (3) corner reflector faces 72, one of which is depicted in FIG. 1, to form a tetrahedron that is open at its base. As illustrated in FIG. 3, when the corner reflector 28 is implanted in the road 32 the open face of the tetrahedron faces upward. Each corner reflector face 72 may be conveniently fabricated by etching a pattern, such as that depicted in FIG. 1, into one of the conductive layers of a double sided sheet of printed circuit board material. For inclusion in the corner reflector 23, the printed circuit board material's insulating layer must be made from a material, such as the preferred material teflon, having characteristics suitable for use at microwave frequencies.

The particular configuration for the corner reflector face 72 depicted in FIG. 1 includes a meandering conductor 74 that originates at one vertex of the triangular-shape and extends almost entirely across the corner reflector face 72 to the side of the triangular-shape opposite the starting vertex. The meandering conductor 74, which provides the corner reflector 28 with its antenna, is formed by connecting a sequence of sinusoidal curves end-to-end. In practice, the meandering conductor 74 includes more sinusoidal segments than depicted in the illustrations of FIGS. 1-3. For example, the meandering conductor 74 included in a corner reflector 28 having a 12 GHz center frequency will have eight (8) sinusoidal segments. The number of sinusoidal segments decreases as the operating frequency of microwave RF increases, and increases as the size of the corner reflector 28 decreases.

The particular configuration for the corner reflector face 72 depicted in FIG. 1 surrounds the meandering conductor 74 with an open area open area 76. For the particular corner reflector face 72 depicted in FIG. 1, the open area 76 is itself is surrounded by an un-etched portion 78 of the double-sided printed circuit board material's conductive layer. Though not separately depicted in FIG. 1-3, the conductive layer on the opposite side of the double sided printed circuit board material from the meandering conductor 74 is not patterned so it forms a ground plane for the patterned side of the corner reflector face 72.

When three (3) of the corner reflector faces 72 are assembled into the corner reflector 23, the vertices of the three (3) corner reflector faces 72 at which each meandering conductor 74 originates are connected together electrically with a dot 82 of solder.

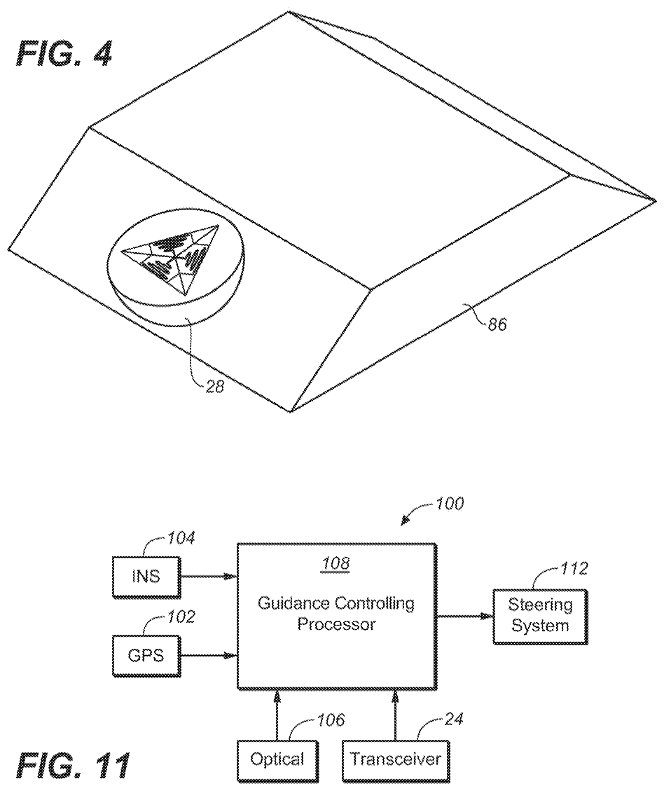

To provide a corner reflector 28 suitable for implantation into a road 32 as depicted in FIG. 3, or incorporation into a conventional highway reflector 86 as depicted in FIG. 4, the assembled corner reflector faces 72 of the comer reflector 28 may be conveniently molded into a hemispherically-shaped package 88 made from material that does not significantly attenuate microwave signals.

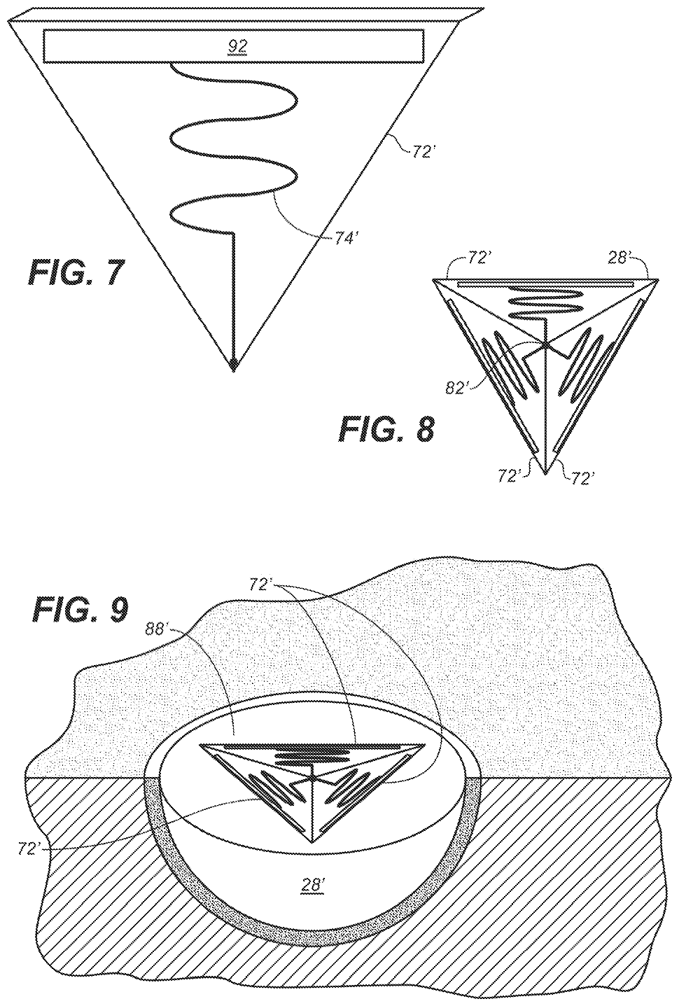

FIGS. 7-9 depict a preferred embodiment for the corner reflector 28 and the corner reflector faces 72 assembled thereinto. Those elements depicted in FIG. 7-9 that are common to the corner reflector 23 and the corner reflector faces 72 illustrated in FIGS. 1-3 carry the same reference numeral distinguished by a prime (“′”) designation.

As depicted in FIG. 7, the preferred corner reflector faces 72′ that are assembled into the corner reflector 28′ differ from the corner reflector faces 72 depicted in FIGS. 1-3 by:
1. omitting the portion 78 that surrounds the meandering conductor 74; and
2. including a rectangularly shaped bar 92 of the conductive layer that connects to the meandering conductor 74′ and is located at the end of the meandering conductor 74′ furthest from the starting vertex thereof.
   Connected to the meandering conductor 74′ as illustrated in FIG. 7, the bar 92 inherently forms part of the antenna of the corner reflector 23′. Furthermore, juxtaposed across the insulating material from the ground plane included in the corner reflector face 72′ described previously for FIGS. 1-3, the bar 92 establishes an approximately fifty picofarad (50 pf) capacitor with the ground plane. Due to the location of the bar 92, this capacitor is located at the end of the meandering conductor 74′ furthest from the starting vertex thereof. Configured in this way, the combined inductance in the meandering conductor 74′ and the bar 92 can be understood as forming a series resonant circuit preferably at the frequency of the microwave RF projected from the transceiver 24.

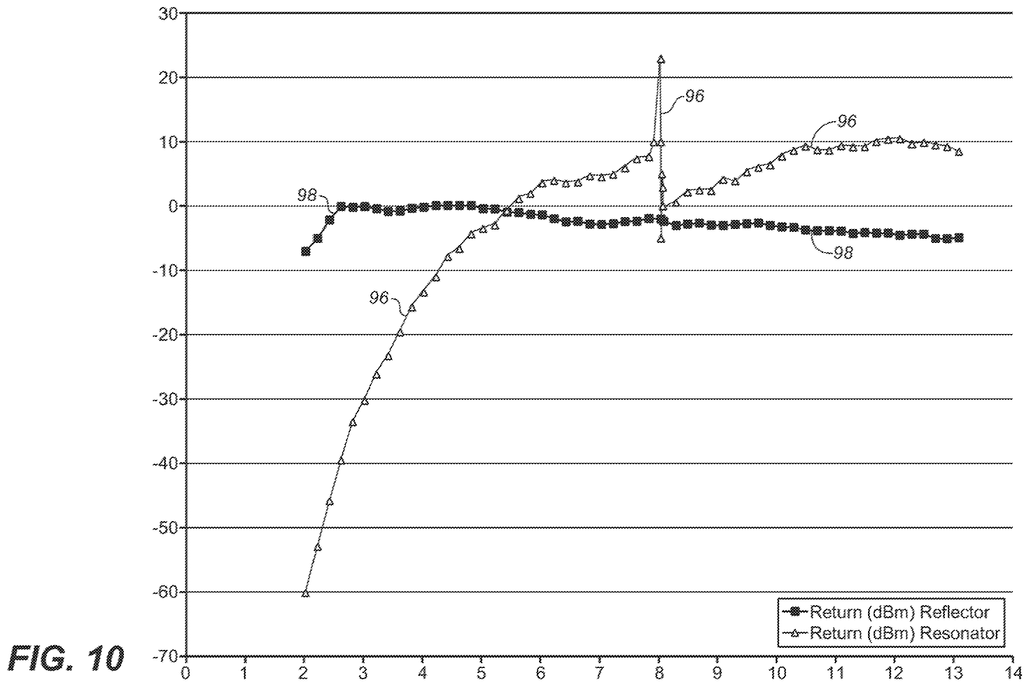

A curve 96 in a FIG. 10 spectrum diagram shows the resonant characteristics exhibited by the preferred corner reflector 28′ having a resonant frequency of approximately 8.0 GHz. A curve 98 in the FIG. 10 spectrum diagram shows the response of a similar corner reflector whose faces lack the resonant producing structure best illustrated in FIG. 7. As depicted in the FIG. 10 spectrum diagram, the corner reflector 28′ exhibits a resonant spike exceeding 30 dBm at its 3.0 GHZ resonant frequency. The receiver portion of the transceiver 24 can use this spike in reflected RF to easily and uniquely distinguish the corner reflector 28′ from interference sources such a metallic foil candy wrapper.

The size of the corner reflector 28 or 28′ varies with frequency of RF projected from the transceiver 24. In general, the larger the size of the corner reflector 28 or 28′ the better, because the surface area of the corner reflector 28 or 28′ determines the amount of power echoed back from the corner reflector 28 or 28′ to the receiving antenna 44. In practice, the minimum workable size for the meandering conductor 74 or 74′ is around one-half lambda (½λ), i.e. one-half the free space wave-length of microwave RF projected from the transceiver 24. The free space wavelength at a frequency of 10.25 GHz is 1.5 cm, and at 24 GHz is 0.6 cm.

It has been noticed that the quality factor (“Q”) of the corner reflector 28′ is very important for its detection by the transceiver 24. The increased Q of the corner reflector 28′ is essential for achieving the response curve that appears in FIG. 10 which assists in distinguishing the corner reflector 28′ from other possible sources that echo microwave RF such as metallic foil candy wrappers.

Electrical performance of the corner reflector 28′ is further enhanced by plating a layer of silver at least one micron (1.0μ) thick onto the meandering conductor 74′ and the bar 92. Oxidation of the silver plating does not appear to adversely affect performance of the corner reflector 28′.

FIG. 11 illustrates a vehicle guidance system for today's self-driving vehicles referred to by the general reference character 100. As described above, the vehicle guidance system 100 may include, in addition to other sensors, some combination of:
1. a global positioning system (“GPS”) 102;
2. inertial guidance 104; and
3. an optical sensor 106 such as a camera or lidar.
   The various sensors included in the vehicle guidance system 100 supply output signals to a guidance controlling processor 108. Responsive to signals received from the various sensors, the guidance controlling processor 108 produces output signals for controlling various aspects of a self-driving vehicle such as its steering system 112 illustrated in FIG. 11.

A vehicle guidance system 100 in accordance with the present disclosure adds to its usual ensemble of sensors such as those depicted in FIG. 11 the transceiver 24. Equipped with the transceiver 24, that portion of the transmitted beam impinging on the corner reflectors 25 which individual corner reflectors 28 echo back to the receiving antenna 44 is processed to thereby provide the vehicle guidance system 100 with a deviation signal that the vehicle guidance system 100 uses in controlling operation of a self-driving vehicle.

Although the present invention has been described in terms of the presently preferred embodiment, it is to be understood that such disclosure is purely illustrative and is not to be interpreted as limiting. Consequently, without departing from the spirit and scope of the disclosure, various alterations, modifications, and/or alternative applications will, no doubt, be suggested to those skilled in the art after having read the preceding disclosure. For example, a retro reflector containing a semiconductor transceiver which returns a coded signal to the receiving antenna 44 would assist in discriminating the corner reflector from potentially interfering materials such as a metallic foil candy wrappers. Such an active corner reflector could be spaced further apart than the corner reflector 28 or 28′. For example, passive resonant corner reflectors 28′ might be embedded 30 yards apart while an active corner reflector might be embedded perhaps at each freeway exit.

Another enhancement to the system is the use of varying retro-corner reflector resonance frequencies. Since the resonant frequency need not be identical for all corner reflector 28 or 28′, different frequencies may be used to indicate different waypoints along a road.

Accordingly, it is intended that the following claims be interpreted as encompassing all alterations, modifications, or alternative applications as fall within the true spirit and scope of the disclosure including equivalents thereof. In effecting the preceding intent, the following claims shall:
1. not invoke paragraph 6 of 35 U.S.C. § 112 as it exists on the date of filing hereof unless the phrase “means for” appears expressly in the claim's text;
2. omit all elements, steps, or functions not expressly appearing therein unless the element, step or function is expressly described as “essential” or “critical;”
3. not be limited by any other aspect of the present disclosure which does not appear explicitly in the claim's text unless the element, step or function is expressly described as “essential” or “critical;” and
   4. when including the transition word “comprises” or “comprising” or any variation thereof, encompass a non-exclusive inclusion, such that a claim which encompasses a process, method, article, or apparatus that comprises a list of steps or elements includes not only those steps or elements but may include other steps or elements not expressly or inherently included in the claim's text.

1. A retro reflector adapted for inclusion in a vehicle guidance system upon which a steered, pencil-shaped, frequency-swept transmitted microwave beam may intermittently impinge and for echoing back toward a receiving antenna a portion of the impinging beam, the retro reflector including a one-piece antenna that comprises only an isolated meandering conductor to thereby provide the retro reflector with an antenna that is resonant at a frequency included among those present in the impinging beam, whereby the retro reflector responds to beam impingement thereon by echoing back toward the receiving antenna a signal having a frequency that is present among those of the impinging beam [for] whereby the frequency echoed back from the retro reflector uniquely identifies the retro reflector.

2-9. (canceled)

10. The retro reflector of claim 1 wherein the retro reflector includes a triangularly-shaped face on which the antenna is formed by the conductor that meanders almost entirely across the triangularly-shaped face from a starting end of the meandering conductor at a vertex of the triangularly-shaped face and extending toward a terminal end of the meandering conductor that is near a side of the triangular-shaped face furthest from the starting end of the meandering conductor.

11. The retro reflector of claim 10 wherein the meandering conductor is formed on a first conductive layer of a double-sided sheet of printed circuit board material, a second conductive layer of the double-sided printed circuit board material furthest from the first conductive layer being unpatterned thereby forming a ground plane for the patterned first conductive layer.

12. The retro reflector of claim 10 having three (3) identical triangularly-shaped faces that are juxtaposed to form a tetrahedron that is open at the base thereof, the vertices of the three (3) juxtaposed triangularly-shaped faces at which each meandering conductor starts meeting at the vertex which is furthest from the open base of the tetrahedron, the adjacent ends of the meandering conductors at each of the respective starting ends being connected together electrically.

13. The retro reflector of claim 10 wherein the retro reflector is molded into a package made from material that does not significantly attenuate the microwave beam.

14. The retro reflector of claim 1 wherein the microwave retro reflector includes a triangularly-shaped face on which the antenna is formed by the conductor that meanders almost entirely across the triangularly-shaped face from a starting end of the meandering conductor at a vertex of the triangularly-shaped face and extending toward a terminal end of the meandering conductor that is near a side of the triangular-shaped face furthest from the starting end of the meandering conductor, the terminal end of the meandering conductor having a bar formed thereat.

15. The retro reflector of claim 14 wherein the meandering conductor is formed on a first conductive layer of a double-sided sheet of printed circuit board material, a second conductive layer of the double-sided printed circuit board material being unpatterned thereby forming a ground plane for the patterned first conductive layer.

16. The retro reflector of claim 14 that includes three (3) identical triangularly-shaped faces that are juxtaposed to form a tetrahedron that is open at the base thereof, the vertices of the three (3) juxtaposed triangularly-shaped faces at which each meandering conductor starts meeting at the vertex which is furthest from the open base of the tetrahedron, the adjacent ends of the meandering conductors at each of the respective starting ends being connected together electrically.

17. The retro reflector of claim 14 wherein the reflector is molded into a package made from material that does not significantly attenuate the microwave beam

18. The retro reflector of claim 11 having three (3) identical triangularly-shaped faces that are juxtaposed to form a tetrahedron that is open at the base thereof, the vertices of the three (3) juxtaposed triangularly-shaped faces at which each meandering conductor starts meeting at the vertex which is furthest from the open base of the tetrahedron, the adjacent ends of the meandering conductors at each of the respective starting ends being connected together electrically.

19. The retro reflector of claim 11 wherein the retro reflector is molded into a package made from material that does not significantly attenuate the microwave beam.

20. The retro reflector of claim 18 wherein the retro reflector is molded into a package made from material that does not significantly attenuate the microwave beam.

21. The retro reflector of claim 15 that includes three (3) identical triangularly-shaped faces that are juxtaposed to form a tetrahedron that is open at the base thereof, the vertices of the three (3) juxtaposed triangularly-shaped faces at which each meandering conductor starts meeting at the vertex which is furthest from the open base of the tetrahedron, the adjacent ends of the meandering conductors at each of the respective starting ends being connected together electrically.

22. The retro reflector of claim 15 wherein the reflector is molded into a package made from material that does not significantly attenuate the microwave beam.

23. The retro reflector of claim 21 wherein the reflector is molded into a package made from material that does not significantly attenuate the microwave beam.
